(19) United States
(12) Patent Application Publication
(10) Pub. No.: US 2017/0083333 A1
(43) Pub. Date: Mar. 23, 2017

(54) BRANCH TARGET INSTRUCTION CACHE (BTIC) TO STORE A CONDITIONAL BRANCH INSTRUCTION

(71) Applicant: QUALCOMM Incorporated, San Diego, CA (US)

(72) Inventors: Niket Kumar CHOUDHARY, Raleigh, NC (US); Michael Scott MCILVAINE, Raleigh, NC (US); Daren Eugene STREETT, Cary, NC (US); Vimal Kodandarama REDDY, Round Rock, TX (US); Shekhar Shashi SRIKANTAIAH, Cary, NC (US); Sandeep Suresh NAVADA, Raleigh, NC (US); Robert Douglas CLANCY, Cary, NC (US); James Norris DIEFFENDERFER, Apex, NC (US); Thomas Andrew SARTORIUS, Raleigh, NC (US)

(21) Appl. No.: 14/859,356

(22) Filed: Sep. 21, 2015

(51) Int. Cl. G06F 9/30; G06F 12/08

(52) U.S. Cl. CPC G06F 9/30058; G06F 12/0875; G06F 2212/452

(57) ABSTRACT

Systems and methods pertain to a branch target instruction cache (BTIC) of a processor. The BTIC is configured to store one or more branch target instructions at branch target addresses of branch instructions executable by the processor. At least one of the branch target instructions stored in the BTIC is a conditional branch instruction. Branch prediction techniques for predicting the direction of the conditional branch instruction allow one or more instructions following the conditional branch instruction, as well as a branch target address of the conditional branch instruction to also be stored in the BTIC.

### FIELD OF DISCLOSURE

Disclosed aspects relate to branch prediction in processing systems. More particularly, exemplary aspects are directed to a branch target instruction cache (BTIC) configured to store conditional branch instructions.

### BACKGROUND

Instruction pipelines of processors are designed to process instructions in multiple pipeline stages, in successive clock cycles. However, cycle “bubbles” may be introduced in some pipeline stages, where a pipeline stage is idle or does not perform useful processing, if requested information or data is not available during the pipeline stage. For example, bubbles may be introduced during the processing of instructions which cause a change in control flow, such as branch instructions. If a branch instruction is “taken,” as known in the art, control flow is transferred to a branch target address of the taken branch instruction. Instructions will need to be fetched from the branch target address which can incur a delay, and bubbles may be introduced while waiting for instructions to be fetched from the branch target address.

Conventional processing of conditional branch instructions, for example, can involve branch prediction mechanisms to predict the direction (taken or not-taken) of a conditional branch instruction. Based on the prediction, the control flow may be transferred to a predicted branch target address if the conditional branch instruction is predicted to be taken, and instructions starting at the predicted branch target address (branch target instructions) may need to be fetched. The branch target instructions may not be readily available in an instruction cache used by the processor due to the change in control flow. Thus, bubbles may be introduced in the instruction pipeline while waiting for the branch target instructions to be fetched. Once introduced, the bubbles propagate through subsequent pipeline stages of the instruction pipeline, thus causing performance of the processor to suffer.

A branch target instruction cache (BTIC) is known in the art for reducing the bubbles. A BTIC is configured to store or cache the branch target instructions for predicted taken branch instructions. When a first branch instruction, for example, is encountered (e.g., early in an instruction pipeline, such as in a fetch stage), and branch prediction mechanisms predict the first branch instruction to be taken, the BTIC is consulted, and the branch target instructions for the first branch instruction can be retrieved. The BTIC may be a small, fast cache, which is indexed by predicted taken branch instructions, and if there is a hit in the BTIC for the first branch instruction, for example, retrieval and subsequent processing of the branch target instructions from the BTIC will minimize or eliminate introduction of bubbles in the instruction pipeline during processing of the first branch instruction.

However, storage of the branch target instructions in the BTIC is terminated if a conditional branch instruction is encountered in the branch target instructions. This is because a conventional BTIC is not designed to support storage of a conditional branch instruction. A conditional branch instruction in the branch target instructions can cause a change in control flow, and so the instructions following the conditional branch instruction may not be down the correct direction. Therefore, storing the instructions past the conditional branch instruction in the BTIC may be useless.

It is difficult to use an existing branch predictor (which was used to predict the direction of the first branch instruction, for example), to also predict the direction of a conditional branch instruction stored in a BTIC because the branch predictor may need to generate multiple predictions in the same cycle for different branch instructions which may reside in different fetch blocks, different cache lines, etc., which a conventional branch predictor is not configured to do. Even if the direction of the conditional branch instruction in the branch target instructions can be predicted by the existing branch predictor, if the direction is predicted to be taken, then the branch target instructions of the conditional branch instructions may reside in a different cache line, and fetching them in order to fill or store them in the BTIC incurs further design challenges.

However, designing the BTIC to efficiently handle storage of conditional branch instructions prevents bubbles, and accordingly, performance from degrading when conditional branch instructions are encountered in branch target instructions. Accordingly, it is desirable to overcome the aforementioned challenges in conventional BTICs.

### SUMMARY

Exemplary aspects of this disclosure are directed to systems and methods pertaining to a branch target instruction cache (BTIC) of a processor. In an exemplary aspect, the BTIC is configured to store one or more branch target instructions at branch target addresses of branch instructions executable by the processor. At least one of the branch target instructions stored in the BTIC is a conditional branch instruction. Branch prediction techniques for predicting the direction of the conditional branch instruction allow one or more instructions following the conditional branch instruction, as well as a branch target address of the conditional branch instruction to also be stored in the BTIC.

For example, an exemplary aspect is directed to a processor comprising a branch target instruction cache (BTIC) configured to store one or more branch target instructions at branch target addresses of branch instructions executable by the processor, wherein at least one of the branch target instructions stored in the BTIC is a conditional branch instruction, and a BTIC-resident branch predictor configured to predict direction of the conditional branch instruction stored in the BTIC.

Another exemplary aspect is directed to a method of processing instructions, the method comprising storing one or more branch target instructions at branch target addresses of branch instructions executable by a processor in a branch target instruction cache (BTIC), wherein at least one of the branch target instructions stored in the BTIC is a conditional branch instruction, and predicting direction of the conditional branch instruction.

Yet another exemplary aspect is directed to an apparatus comprising means for storing one or more branch target instructions at branch target addresses of branch instructions executable by a processor, wherein at least one of the branch target instructions is a conditional branch instruction, and means for predicting direction of the conditional branch instruction.

Yet another exemplary aspect is directed to a non-transitory computer readable storage medium comprising code for storing one or more branch target instructions at branch target addresses of branch instructions executable by a processor in a branch target instruction cache (BTIC), wherein at least one of the branch target instructions stored in the BTIC is a conditional branch instruction, and code for predicting direction of the conditional branch instruction.

### BRIEF DESCRIPTION OF THE DRAWINGS

The accompanying drawings are presented to aid in the description of aspects of the invention and are provided solely for illustration of the aspects and not limitation thereof.

FIG. 1A illustrates a processor comprising an exemplary branch target instruction cache (BTIC).

FIG. 1B illustrates branch prediction mechanisms pertaining to the BTIC of FIG. 1A.

FIG. 1C illustrates a schematic view of the processor of FIG. 1A.

FIG. 2 illustrates a process flow for processing instructions according to an exemplary aspect of this disclosure.

FIG. 3 illustrates an exemplary wireless device 300 in which an aspect of the disclosure may be advantageously employed.

### DETAILED DESCRIPTION

Aspects of the invention are disclosed in the following description and related drawings directed to specific aspects of the invention. Alternative aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects relate to overcoming the aforementioned limitations of conventional branch target instruction caches (BTICs), and enabling exemplary BTICs to efficiently handle storage of conditional branch instructions. A conditional branch instruction stored in a BTIC is referred to as a BTIC-resident branch instruction. Exemplary aspects also relate to a processor configured to access exemplary BTICs comprising BTIC-resident branch instructions. Branch instructions whose target branch instructions are stored in the BTIC (also referred to as BTIC-hitting branch instructions), can retrieve branch target instructions which can include a BTIC-resident branch instruction. Thus, bubbles can be minimized or eliminated during processing of the BTIC-hitting branch instruction in an instruction pipeline of the processor. The exemplary aspects will be explained in detail with reference to the figures below.

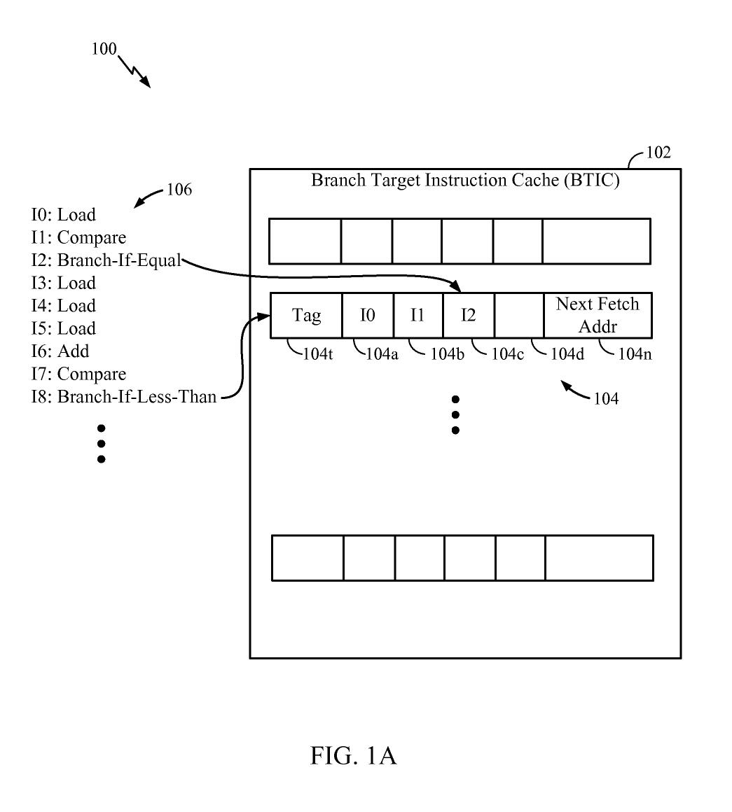

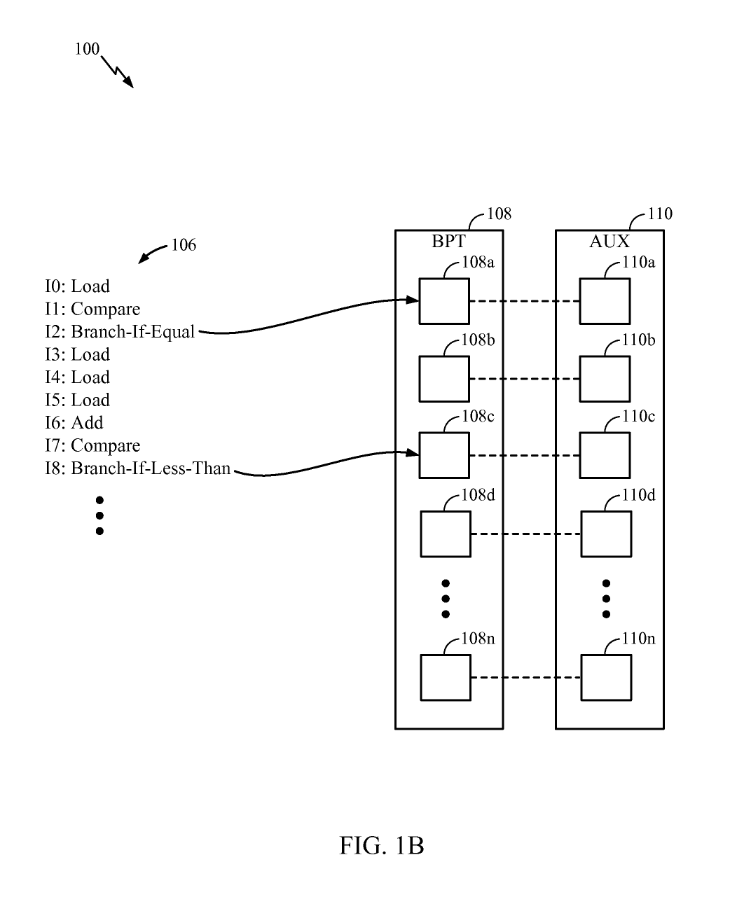

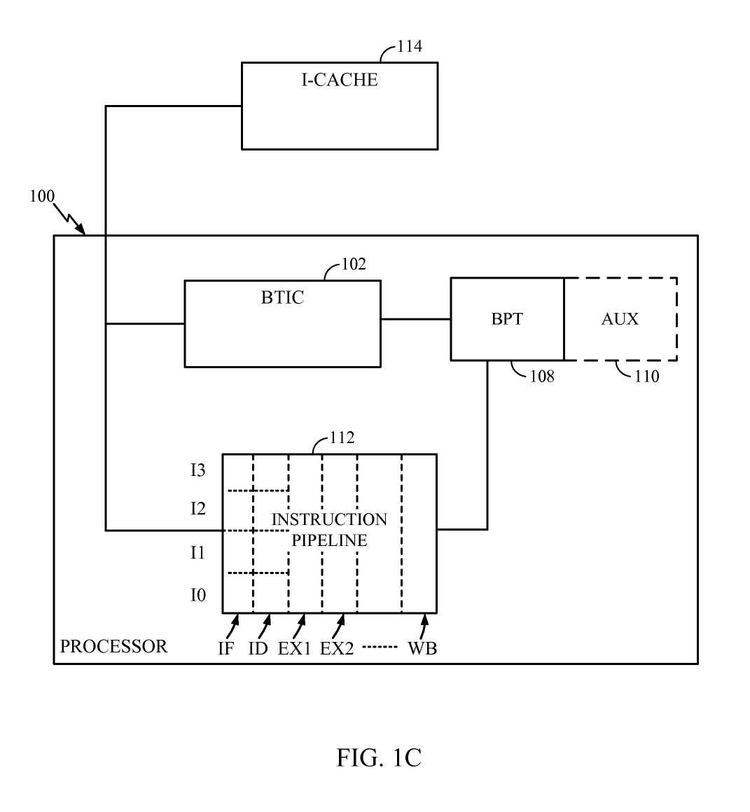

With reference to FIG. 1A, some aspects pertaining to exemplary features of processor 100 are illustrated. Specifically, branch target instruction cache (BTIC) 102 and an example code sequence 106 that can be executed in processor 100 are shown. Various other aspects of processor 100, such as an instruction cache, instruction pipeline, register files, branch prediction mechanisms, etc., are not shown in this view, but will be understood by one skilled in the art. FIG. 1C also provides additional details for an example configuration of processor 100. Processor 100 may be a superscalar processor configured to fetch and execute two or more instructions in parallel in each clock cycle.

Considering code sequence 106 in further detail, nine instructions including instructions I0-I8 are shown. Instructions I0, I3, I4, and I5 are generally shown to be load instructions, where they can be any type of load instruction supported by an instruction set architecture (ISA) of processor 100. Similarly, instructions I1 and I7 are generally shown as any type of compare instructions and I6 is generally an add instruction. In general, instructions I0, I1, and I3-I7 can be any type of instruction which does not cause a change in control flow of code sequence 106. On the other hand, instructions I2 and I8 can cause a change in control flow.

Instruction I2 is a conditional branch instruction, specifically shown as a branch-if-equal instruction, wherein the behavior of instruction I2 is to branch to a destination or branch target address if a condition (i.e., “equal”) evaluates to be true, causing the branch to be “taken.” This means that if the “equal” condition evaluates to be true, then instruction I2 causes a change in control flow for code sequence 106, to execute branch target instructions starting from a branch target instruction specified by instruction I2. Otherwise, execution flow proceeds to instruction I3.

Similarly, instruction I8 is also shown as a conditional branch instruction, specifically, branch-if-less-than, where if a condition of instruction I8 (i.e., “less-than”) evaluates to be true, a change in control flow results, causing branch target instructions at a branch target address of instruction I8 to be executed. Otherwise, control flow would proceed to an instruction (say, I9, not shown) following instruction I8 in code sequence 106. In the illustrated example, the branch target address of instruction I8 is considered to be instruction I0. In other words, if instruction I8 is “taken,” then control flow loops back to instruction I0 (instruction I8 may be a loop branch instruction, for example, where if instruction I8 is taken, instructions I0-I8 will be executed in a loop). As previously explained, branch target instructions at a branch target address may not be readily available in an instruction cache (for example, in this case, instruction I0 may have been replaced in an instruction cache of processor 100 by the time execution reached instruction I8, and therefore, when control flow is directed to instruction I0, there may be a miss in the instruction cache), leading to delays/pipeline bubbles. In order to avoid bubbles, BTIC 102 is provided.

BTIC 102 is configured as a cache to store branch target instructions. Thus, whenever a branch instruction is resolved or predicted to be taken, branch target instructions at the branch target address are stored in BTIC 102, with the expectation that the behavior of the branch instruction will be the same the next time it is encountered in the same program or code sequence. When the branch instruction is encountered next, BTIC 102 is consulted to see if BTIC 102 holds an entry for the branch instruction, and if it does, the branch instruction is referred to as a BTIC-hitting branch instruction. Branch target instructions for the BTIC-hitting branch instruction are retrieved from BTIC 102, rather than from an instruction cache or other backing storage locations if there is a miss in the instruction cache.

Accordingly, BTIC 102 includes one or more entries which comprise branch target addresses for BTIC-hitting branch instructions. Entry 104 is particularly shown, corresponding to instruction I8, which is considered to be a BTIC-hitting branch instruction in this example (it will be understood that BTIC 102 may also have an entry for branch target instructions of instruction I2, but that is not relevant to the discussion of exemplary aspects). Entry 104 includes several fields including tag 104t, which can include some or all bits of an operation code (Op-Code) or other identifier of instruction I8. When instruction I8 is encountered in the execution of code sequence 106, BTIC 102 is consulted to see if any of the entries have a tag corresponding to instruction I8. In this case, since tag 104t is assumed to correspond to instruction I8, instruction I8 is considered to be a BTIC-hitting branch instruction. Branch target instructions for instruction I8 are stored in one or more instruction fields such as 104a, 104b, 104c, 104d, etc. Next fetch address 104n is another field of entry 104 which will be discussed further in the following sections. In superscalar processors, two or more instructions can be fetched in a single clock cycle, to be processed in parallel. Thus, entries of BTIC 102 can have two or more instruction fields 104a-d to store two or more branch target instructions which can be retrieved in parallel to be processed in processor 100, wherein processor 100 is configured as a superscalar processor.

As seen, since instruction I0 is the instruction located at the branch target address of instruction I8, when instruction I8 is taken, one or more branch target instructions including instruction I0 will be processed following instruction I8. Specifically, instructions I0, I1, and I2 are branch target instructions, which can be stored in instruction fields 104a, 104b, and 104c of entry 104. However, instruction I2 is itself a conditional branch instruction, as noted above. When a conditional branch instruction such as instruction I2 is stored in BTIC 102, the conditional branch instruction is referred to as a BTIC-resident branch instruction. The BTIC-resident branch instruction, instruction I2, can cause a change in control flow. Therefore, if instruction I2 is taken, control flow would switch to the branch target address of instruction I2 (e.g., instruction I2 can be a loop exit branch instruction, wherein control flow can exit the loop created by loop branch instruction I8 if instruction I2 is taken). If instruction I2 is not-taken, then control flow would follow code sequence 106, and instruction I3 would follow instruction I2 (e.g., when the looping behavior continues and the loop has not yet been exited). As discussed previously, conventional BTICs are not designed to store BTIC-resident branch instructions because of the challenges involved in predicting or knowing the direction in which a BTIC-resident branch will resolve. In other words, instruction fields such as 104c, 104d, etc., would be wasted fetch slots in conventional designs which cannot store instruction I2 and following instructions past instruction I2.

Systems and methods for in-time (e.g., on the fly, during execution) branch prediction for BTIC-resident branch instructions such as instruction I2 are provided in exemplary aspects. Exemplary branch prediction techniques for BTIC-resident branch instructions make it possible to store conditional branch instructions in BTIC 102. Moreover, one or more instructions (e.g., in instruction field 104d) following the BTIC-resident branch instructions can also be stored in BTIC 102. The number of instructions past the BTIC-resident branch instruction that can be stored in BTIC 102 may be based on a maximum fetch bandwidth supported by processor 100 (e.g., where processor 100 is implemented as a superscalar processor). Branch prediction for the BTIC-resident branch instruction can be based on behavior or history of the corresponding BTIC-hitting branch instruction.

With reference now to FIG. 1B, a first aspect of branch prediction for a BTIC-resident branch instruction will be explained. As shown, processor 100 can include branch prediction table (BPT) 108 to provide predictions for branch instructions encountered in execution of program code. BPT 108 can be configured according to conventional techniques known in the art. A history of predictions/evaluations of conditional branch instructions (e.g., a pattern of taken/not-taken) that traverse or have traversed through an instruction pipeline of processor 100 can be tracked (e.g., in a branch history table or “BHT” as known in the art). BPT 108 can have one or more entries, designated as 108a-n, comprising branch predictions. BPT 108 can be indexed directly by branch instructions (e.g., instructions I2, I8 of code sequence 106), or may be combined with other information, such as the BHT. For example, the pattern stored in the BHT and the address or program counter (PC) values of instructions I2, I8 can be combined in a function such as concatenation, XOR, etc., (generally referred to as a hash function) to map instructions to specific entries 108a-n of BPT 108. As shown, instruction I2 can map or index to entry 108a and instruction I8 can map or index to entry 108c, without loss of generality.

Entries 108a-n may comprise one or more branch predictors, such as state machines implemented, for example, using saturating counters or bimodal branch predictors. For example, each entry 108a-n may comprise a counter (e.g., a 2-bit counter) that assumes one of four states, each assigned a weighted prediction value, such as: “11” or strongly predicted taken; “10” or weakly predicted taken; “01” or weakly predicted not taken; and “00” or strongly predicted not taken. The counter is incremented each time a corresponding branch instruction which maps to the entry evaluates “taken” and decremented each time the branch instruction evaluates “not-taken.” The most significant bit (MSB) of the counter is a bimodal branch predictor, wherein the MSB indicates a prediction of whether a branch will be taken or not-taken. A saturating counter implemented in this manner reduces the prediction error that may be caused by an infrequent branch evaluation. A branch instruction that consistently evaluates one way will saturate the counter. An infrequent evaluation the other way will alter the counter value (and the strength of the prediction), but not the MSB. Thus, an infrequent evaluation may only mispredict once, not twice.

The use of saturating counters is an illustrative example only; in general, exemplary branch prediction mechanisms may include other forms of state machines. Regardless of the particular type of branch prediction mechanism or state machine employed (e.g. in BPT 108), by storing prior branch evaluations in a BHT and using the evaluations in branch prediction, the branch instruction being predicted is correlated to past branch behavior, such as its own past behavior (e.g., a “local history”) and/or the behavior of other branch instructions (e.g., a “global history”).

However, BPT 108 is not trained or configured to predict the behavior of BTIC-resident branch instructions. Thus, an auxiliary branch prediction mechanism such as auxiliary table, aux 110, is provided for BTIC-resident branch instructions in exemplary aspects, in addition to existing branch prediction mechanisms such as BPT 108 in processor 100. Aux 110 can also be implemented similar to BPT 108, i.e., comprising a corresponding number of entries 110a-n. Entries 110a-n may include auxiliary state machines such as saturating counters, similar to entries 108a-n of BPT 108. Aux 110 can be bundled with or coupled to BPT 108, to provide an extra prediction for BTIC-resident branch instructions.

In more detail, branch instructions I2 and I8 index to entries 108a and 108c in BPT 108 as previously described. Thus, entry 108c provides predictions for the direction of branch instruction I8. Entry 108c may be referred to as BTIC-hitting branch entry, which provides a prediction of the direction of a BTIC-hitting branch instruction I8, whose predicted branch target instructions are stored in the BTIC. However, entry 110c of aux 110 provides predictions for a BTIC-resident branch instruction in BTIC 102 for instruction I8, when instruction I8 is a BTIC-hitting branch instruction. In other words, with combined reference to FIGS. 1A-B, when a BTIC-hitting branch instruction I8 encounters a BTIC-resident branch instruction I2 in entry 104c of BTIC 102, aux 110 is accessed. Based on the value of the counter corresponding to the indexed entry 108c for instruction I8, entry 110c of aux 110 is used to determine a prediction for BTIC-resident branch instruction I2. Accordingly, entry 110c may be referred to as a BTIC-resident branch predictor, to predict direction of the BTIC-resident branch instruction I2 or conditional branch instruction stored in BTIC 102.

Referring to FIG. 1A, the branch target instruction for BTIC-resident branch instruction I2 is also stored in next fetch address 104n of entry 104. Thus, if BTIC-resident branch instruction I2 is predicted to be taken, based on entry 110c of aux 110, the branch target instruction of BTIC-resident branch instruction I2 is used when entry 104 is fetched. If BTIC-resident branch instruction I2 is predicted to be not-taken, then one or more instructions past BTIC-resident branch instruction I2 (e.g., instruction I3 in instruction field 104d) are used. In either case, i.e., whether BTIC-resident branch instruction I2 is predicted to be taken or not-taken, branch target instructions for BTIC-hitting branch instruction I8 are made available including and past BTIC-resident branch instruction I2, by exemplary BTIC 102. Accordingly, pipeline bubbles can be avoided.

It will be noted that implementation of the auxiliary table, aux 110 may involve hardware in addition to existing BPT 108 implemented in processor 100. In other words, an additional prediction is provided by entries 110a-n even when only the entries 108a-n of BPT 108 are accessed for conventional branch prediction (i.e., not related to BTIC-resident branch instructions).

In a second aspect of branch prediction for BTIC-resident branch instruction I2, aux 110 is not provided. On the other hand, a different entry, such as a second entry other than the BTIC-hitting branch entry 108c of BPT 108, is reused or repurposed to provide a prediction for BTIC-resident branch instruction I2. More specifically, a second entry (e.g., entry 108d), adjacent to or following entry 108c indexed by BTIC-hitting branch instruction I8 in BPT 108 is repurposed to provide an in-time prediction for BTIC-resident branch instruction I2. To further explain this aspect, it will be recognized that when a branch instruction is predicted to be taken (as is the case with a BTIC-hitting branch instruction which accesses BTIC 102 to retrieve branch target instructions based on being predicted to be taken), the counters in a second entry adjacent to or following the BTIC-hitting branch entry indexed by the taken branch instruction is not used for branch prediction in the same cycle that branch prediction is made for the taken branch instruction. For example, if instruction I10 is a branch instruction which follows instruction I8 in code sequence 106, if instruction I8 is predicted to be taken, control flow would transfer to the branch target address of instruction I8 (i.e., to instruction I0 in the above-illustrated examples), causing instruction I10 to no longer be executed in a particular instance. Thus, in this case, if entry 108d is indexed by instruction I10, the state machine or counter in entry 108d can be repurposed to provide a branch prediction for BTIC-resident branch instruction I2 instead. Entry 108d can be trained based on behavior of BTIC-resident branch instruction I2. Thus, reusing or repurposing an entry of BPT 108 can save on implementing an additional structure such as aux 110 for providing branch prediction of BTIC-resident branch instructions.

A third aspect is also disclosed wherein a different entry of BPT 108 is used for providing branch prediction of BTIC-resident branch instructions. In this case, a third entry, for example, of BPT 108, corresponding to the last branch instruction in a fetch group is reused or repurposed to provide branch prediction of BTIC-resident branch instructions. For example, where two or more branch instructions are fetched in each clock cycle of processor 100 configured as a superscalar processor, entry 108n may correspond to the last branch instruction in a fetch group, and entry 108n may be used to train BTIC-resident branch instruction I2 for entry 104 of BTIC-hitting branch instruction I8.

Accordingly, in the various aspects discussed above, instructions including and past a BTIC-resident branch instruction can be fetched, and stored in a single BTIC entry. In exemplary aspects, a BTIC entry can be populated with at most one BTIC-resident branch instruction and one or more instructions past the at most one BTIC-resident branch instruction. Populating a BTIC entry with more than one BTIC-resident branch instruction may be possible by extending the concepts disclosed herein, but a detailed explanation of such cases is avoided herein for the sake of simplicity. It is seen that in exemplary aspects, the throughput or number of instructions that can be fetched and processed in each cycle (e.g., in a superscalar processor) is increased by enabling conditional branches to be stored in the exemplary BTIC. For BTIC-hitting branch instructions, fetch bubbles for the BTIC-hitting branch instruction, as well as fetch bubbles for the BTIC-resident branch instruction are eliminated. Moreover, if the BTIC-resident branch instruction is predicted to be not-taken, then as many following instructions as will be supported by the maximum fetch bandwidth of the processor can be populated in the BTIC entry.

With reference now to FIG. 1C, an example implementation of processor 100 configured according to above-described aspects is illustrated. Processor 100 can be a general purpose processor, special purpose processor such as a digital signal processor (DSP), etc., and in some aspects, can be a superscalar processor. Processor 100 can be coupled to instruction cache or I-cache 114. Processor 100 may be configured to receive one or more instructions from I-cache 114 and execute the instructions using for example, instruction pipeline 112. Further, for BTIC-hitting branch instructions, one or more instructions (which can include BTIC-resident branch instructions) can be fetched from BTIC 102 and executed in instruction pipeline 112. Instruction pipeline 112 may include one or more pipelined stages, representatively illustrated as stages: instruction fetch (IF), instruction decode (ID), one or more execution stages EX1, EX2, etc., and a write back (WB) stage. In an example, instructions I0, I1, I2, and I3 are shown to enter IF stage of instruction pipeline 112 in parallel to illustrate that processor 100 can be a superscalar processor. BPT 108 can provide branch predictions that can be used for speculative execution of branch instructions in instruction pipeline 112, as discussed above. Further, once branch instructions have executed, it can be determined whether the predictions upon which they were executed were correct and this information can be used to train BPT 108. When predictions are incorrect, instructions fetched in wrong-paths will be flushed and correct-path instructions will be replayed, as known in the art. Aux 110 is also shown as an optional block in processor 100 and can be implemented in aspects which include the auxiliary table for branch prediction of BTIC-resident branch instructions. In other aspects where aux 110 is not used, entries of BPT 108 may be repurposed to provide branch prediction of BTIC-resident branch instructions. Further details of processor 100 will be understood by one skilled in the art, based on the description of exemplary aspects herein.

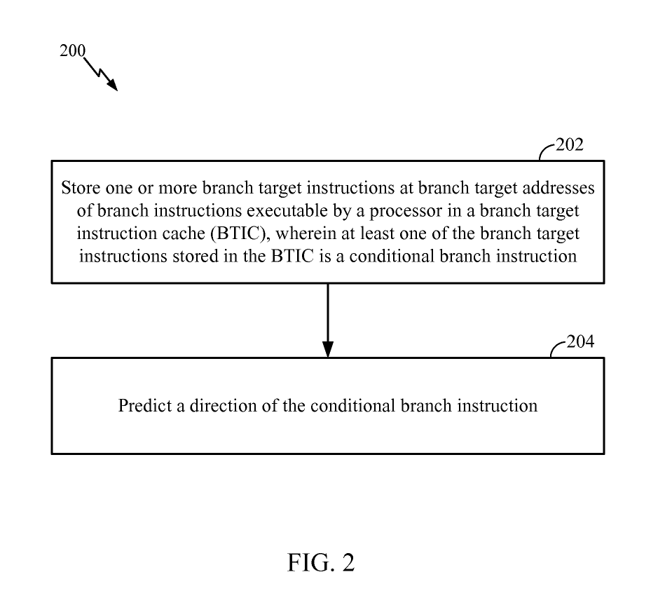

Accordingly, it will be appreciated that exemplary aspects include various methods for performing the processes, functions and/or algorithms disclosed herein. For example, FIG. 2 illustrates method 200 for processing instructions. Method 200 can be performed, for example, in processor 100.

In Block 202, method 200 can include storing one or more branch target instructions at branch target addresses of branch instructions executable by a processor in a branch target instruction cache (BTIC), wherein at least one of the branch target instructions stored in the BTIC is a conditional branch instruction. For example, Block 202 can pertain to storing BTIC-resident branch instruction I2 in entry 104 of BTIC 102.

In Block 204, method 200 can further include predicting direction of the conditional branch instruction. In an example, Block 204 may pertain to predicting the direction of BTIC-resident branch instruction I2 using, for example, counters of aux 110, a second entry of BPT 108 corresponding to an entry adjacent to a BTIC-hitting branch entry, or a third entry of BPT 108 corresponding to a last branch instruction in a fetch group comprising the BTIC-hitting branch instruction.

Moreover, it will also be appreciated that aspects of this disclosure include any apparatus comprising means for performing the above-described functionality. For example, in exemplary aspects, BTIC 102 can include means for storing one or more branch target instructions at branch target addresses of branch instructions executable by a processor are disclosed (e.g., BTIC 102 configured to store one or more branch target instructions at branch target addresses of BTIC-hitting branch instruction I8 of code sequence 106 executable by processor 100). Accordingly, in an aspect, BTIC 102 can include means for storing two or more instructions including the conditional branch instruction and one or more instructions following the conditional branch instruction (e.g., entries 104a-n of BTIC 102), for example, in cases where processor 100 is configured as a superscalar processor. In an aspect, at least one of the branch target instructions is a conditional branch instruction (e.g., BTIC-resident branch instruction I2). Exemplary aspects can also include BPT 108 comprising a BTIC-hitting branch entry which includes means for predicting direction of a branch instruction whose predicted branch target instructions are stored in BTIC 102. In exemplary aspects, means for predicting direction of the conditional branch instruction (e.g., counters of aux 110, a second entry of BPT 108 adjacent to a BTIC-hitting branch entry or a third entry of BPT 108 which corresponds to a last branch instruction in a fetch group comprising the BTIC-hitting branch instruction) and means for storing a predicted branch target address of the conditional branch instruction (e.g., in next fetch address 104n of BTIC 102) are also disclosed. Accordingly, means for storing conditional branch instructions in a BTIC and means for predicting direction of the conditional branch instructions stored in the BTIC are disclosed in exemplary aspects.

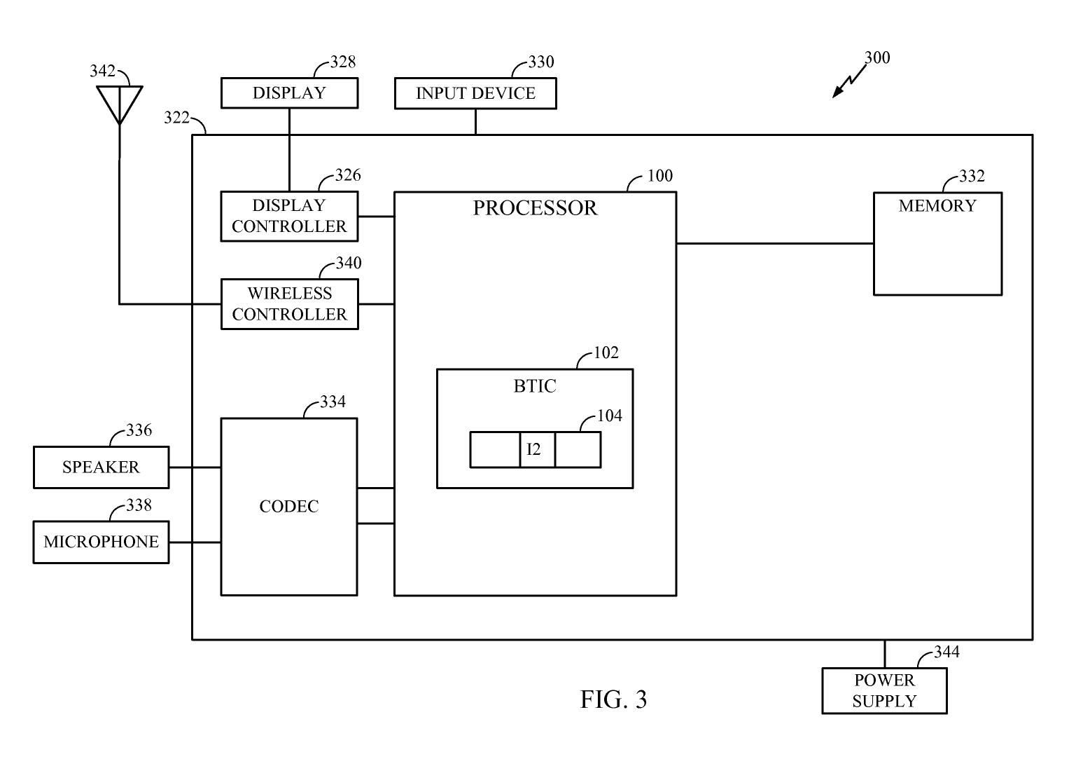

Referring now to FIG. 3, a block diagram of a wireless device that is configured according to exemplary aspects is depicted and generally designated 300. Wireless device 300 includes processor 100 of FIGS. 1A-C, which is configured to implement method 200 of FIG. 2 in some aspects. Processor 100 is shown to comprise BTIC 102 with entry 104 holding BTIC-resident branch instruction I2 particularly shown. Other details have been omitted from this view of processor 100 for the sake of clarity, but are consistent with the description of FIGS. 1A-C provided previously. Processor 100 may be communicatively coupled to memory 332.

FIG. 3 also shows display controller 326 that is coupled to processor 100 and to display 328. Coder/decoder (CODEC) 334 (e.g., an audio and/or voice CODEC) can be coupled to processor 100. Other components, such as wireless controller 340 (which may include a modem) are also illustrated. Speaker 336 and microphone 338 can be coupled to CODEC 334. FIG. 3 also indicates that wireless controller 340 can be coupled to wireless antenna 342. In a particular aspect, processor 100, display controller 326, memory 332, CODEC 334, and wireless controller 340 are included in a system-in-package or system-on-chip device 322.

In a particular aspect, input device 330 and power supply 344 are coupled to the system-on-chip device 322. Moreover, in a particular aspect, as illustrated in FIG. 3, display 328, input device 330, speaker 336, microphone 338, wireless antenna 342, and power supply 344 are external to the system-on-chip device 322. However, each of display 328, input device 330, speaker 336, microphone 338, wireless antenna 342, and power supply 344 can be coupled to a component of the system-on-chip device 322, such as an interface or a controller.

It should be noted that although FIG. 3 depicts a wireless communications device, processor 100 and memory 332 may also be integrated into a set top box, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for storing conditional branch instructions in a branch target instruction cache. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A processor comprising:
a branch target instruction cache (BTIC) configured to store one or more branch target instructions at branch target addresses of branch instructions executable by the processor, wherein at least one of the branch target instructions stored in the BTIC is a conditional branch instruction; and
a BTIC-resident branch predictor configured to predict direction of the conditional branch instruction stored in the BTIC.

2. The processor of claim 1, wherein the BTIC is further configured to store a predicted branch target address of the conditional branch instruction stored in the BTIC.

3. The processor of claim 1 configured as a superscalar processor, wherein an entry of the BTIC comprises two or more instructions including the conditional branch instruction and one or more instructions following the conditional branch instruction.

4. The processor of claim 1, further comprising a branch prediction table (BPT) with a BTIC-hitting branch entry configured to predict direction of a BTIC-hitting branch instruction whose predicted branch target instructions are stored in the BTIC.

5. The processor of claim 4, further comprising an auxiliary table comprising the BTIC-resident branch predictor, wherein the BTIC-hitting branch entry is associated with the BTIC-resident branch predictor.

6. The processor of claim 5, wherein the BTIC-hitting branch entry and the BTIC-resident branch predictor comprise saturating counters.

7. The processor of claim 4, wherein the BPT comprises a second entry adjacent to the BTIC-hitting branch entry, wherein the second entry comprises the BTIC-resident branch predictor configured to predict direction of the conditional branch instruction.

8. The processor of claim 4, wherein the BPT comprises a third entry corresponding to a last branch instruction in a fetch group comprising the BTIC-hitting branch instruction, wherein the third entry comprises the BTIC-resident branch predictor configured to predict direction of the conditional branch instruction.

9. The processor of claim 1, integrated into a device selected from the group consisting of a set top box, music player, video player, entertainment unit, navigation device, personal digital assistant (PDA), fixed location data unit, computer, laptop, tablet, communications device, and a mobile phone.

10. A method of processing instructions, the method comprising:
storing one or more branch target instructions at branch target addresses of branch instructions executable by a processor in a branch target instruction cache (BTIC), wherein at least one of the branch target instructions stored in the BTIC is a conditional branch instruction; and
predicting direction of the conditional branch instruction.

11. The method of claim 10, further comprising storing a predicted branch target address of the conditional branch instruction in the BTIC.

12. The method of claim 10 further comprising, storing two or more instructions including the conditional branch instruction and one or more instructions following the conditional branch instruction in an entry of the BTIC, wherein the processor is a superscalar processor.

13. The method of claim 10, further comprising predicting direction of a BTIC-hitting branch instruction whose predicted branch target instructions are stored in the BTIC, based on a BTIC-hitting branch entry of a branch prediction table (BPT).

14. The method of claim 13, further comprising predicting direction of the conditional branch instruction based on a BTIC-resident branch predictor of an auxiliary table, wherein the BTIC-hitting branch entry is associated with the BTIC-resident branch predictor.

15. The method of claim 14, wherein the BTIC-hitting branch entry and the BTIC-resident branch predictor comprise saturating counters.

16. The method of claim 13, further comprising predicting direction of the conditional branch instruction based on a second entry of the BPT adjacent to the BTIC-hitting branch entry.

17. The method of claim 13, further comprising predicting direction of the conditional branch instruction based on a third entry of the BPT corresponding to a last branch instruction in a fetch group comprising the BTIC-hitting branch instruction.

18. An apparatus comprising:
means for storing one or more branch target instructions at branch target addresses of branch instructions executable by a processor, wherein at least one of the branch target instructions is a conditional branch instruction; and
means for predicting direction of the conditional branch instruction.

19. The apparatus of claim 18, further comprising means for storing a predicted branch target address of the conditional branch instruction.

20. The apparatus of claim 18, further comprising means for storing two or more instructions including the conditional branch instruction and one or more instructions following the conditional branch instruction, wherein the processor is a superscalar processor.

21. The apparatus of claim 18, further comprising means for predicting direction of a branch instruction whose predicted branch target instructions are stored in the means for storing.

22. A non-transitory computer readable storage medium comprising:
code for storing one or more branch target instructions at branch target addresses of branch instructions executable by a processor in a branch target instruction cache (BTIC), wherein at least one of the branch target instructions stored in the BTIC is a conditional branch instruction; and
code for predicting direction of the conditional branch instruction.

23. The non-transitory computer readable storage medium of claim 22, further comprising code for storing a predicted branch target address of the conditional branch instruction in the BTIC.

24. The non-transitory computer readable storage medium of claim 22, further comprising, code for storing two or more instructions including the conditional branch instruction and one or more instructions following the conditional branch instruction in an entry of the BTIC, wherein the processor is a superscalar processor.

25. The non-transitory computer readable storage medium of claim 22, further comprising code for predicting direction of a BTIC-hitting branch instruction whose predicted branch target instructions are stored in the BTIC, based on a BTIC-hitting branch entry of a branch prediction table (BPT).

26. The non-transitory computer readable storage medium of claim 25, further comprising code for predicting direction of the conditional branch instruction based on a BTIC-resident branch predictor of an auxiliary table, wherein the BTIC-hitting branch entry is associated with the BTIC-resident branch predictor.

27. The non-transitory computer readable storage medium of claim 25, further comprising code for predicting direction of the conditional branch instruction based on a second entry of the BPT adjacent to the BTIC-hitting branch entry.

28. The non-transitory computer readable storage medium of claim 25, further comprising code for predicting direction of the conditional branch instruction based on a third entry of the BPT corresponding to a last branch instruction in a fetch group comprising the BTIC-hitting branch instruction.
